(19) United States
(12) Patent Application Publication
(10) Pub. No.: US 2007/0168821 A1
(43) Pub. Date: Jul. 19, 2007

(54) Arq control in an hsdpa communications system

(75) Inventor: Phong Nguyen, Victoria (AU)

Correspondence Address: YOUNG & THOMPSON, 745 SOUTH 23RD STREET, 2ND FLOOR, ARLINGTON, VA, 22202, US

(73) Assignee: NEC CORPORATION, Tokyo (JP)

(21) Appl. No.: 10/576,113

(22) PCT Filed: Oct. 15, 2004
(86) PCT No.: PCT/JP04/15650

§ 371 Date: Apr. 14, 2006

(30) Foreign Application Priority Data
Oct. 17, 2003 (AU) 2003905712

(51) Int. Cl. H04L 1/18

(52) U.S. Cl. 714/748

(57) ABSTRACT

A method of Automatic Repeat request (ARQ) control in a High Speed Downlink Packet Access (HSDPA) communication system. The method includes transmitting (300) control information from a first station to a second station; commencing receipt (312) of the control information at the second station; checking (502) whether the control information was received with error; and if so, generating (604) a negative acknowledgment (NACK) message for transmission to the first station. The control information error checking and acknowledgment message generating is performed at the second station by carrying out processing operations within radio interface layer 1 (UE layer 1).

### TECHNICAL FIELD

The present invention relates generally to error control of data transmitted between stations in a communications system, and more particularly to Automatic Repeat reQuest (ARQ) control in a High Speed Downlink Packet Access (HSDPA) communications system.

### BACKGROUND ART

HSDPA is one of the key features of the third generation (3G) wireless communications standard for Wideband Code Division Access (W-CDMA). W-CDMA is proposed to support multimedia services in the downlink direction. As the name implies, HSDPA brings high speed data delivery to 3G stations, ensuring that users requiring effective multimedia capabilities benefit from data rates previously unavailable because of limitations in the radio access network. HSDPA is intended to provide very high data rates in the downlink direction of up to 14.4 Mbps over 5 MHz band width. High quality applications such as video streaming, interactive applications and video on demand are intended to be guaranteed. In order to reach this target, standard participants have investigated several key technologies, including Adaptive Modulation and Coding (AMC) and Hybrid-ARQ (H-ARQ). HSDPA uses H-ARQ and AMC to improve data throughput.

The transmission time interval for an HSDPA related channel is defined at a “sub-frame” level where one sub-frame is equivalent to three slots (2 ms). This means that radio interface layer 1 channel parameters and conditions may change every three slots. The use of AMC techniques means that an HSDPA station must be capable of changing its demodulation scheme between QPSK and 16 QAM, and the number of physical channels depending on signalling sent with the data on the relevant control channel. The signalling sent on the control channel consists of necessary information for receiving and decoding data sent on the data channel.

In order to assist a base station (node B) to select the appropriate modulation scheme and coding rate for the channel conditions currently being experienced by a mobile receiver (UE), the UE sends channel quality information to node B via a specific control channel. Moreover, in order to assist node B in performing the ARQ procedure, the UE sends a message back to node B to indicate whether a data packet was received with or without error on the dedicated control channel. The UE sends either a positive acknowledgement (ACK) message indicating that a packet of data was transmitted to the UE without error, or a negative acknowledgement (NACK) message indicating that the data packet was transmitted with errors. The ACK or NACK message is then used by node B to perform retransmission of a data packet if required.

When HSDPA activity is initiated, node B starts sending control information to an intended UE on a common channel. These operations are performed by carrying out processing operations within radio interface layer 1. The UE monitors the given common control channel, and once control information intended for that UE is detected, starts receiving packet data on the associated data channel by using the partially decoded control information. Simultaneously, the UE continues retrieving control information on the detected control channel and performs error detection, once again by carrying out processing operation within radio interface layer 1. If no error is detected, the UE will continue receiving and decoding packet data.

Upon completion of receiving and decoding the packet data, the complete data packet is sent from radio interface layer 1 to radio interface layer 2. Upon reception of the complete packet data, H-ARQ processing of the data packet is carried out by performing operations within radio interface layer 2. At the conclusion of the H-ARQ processing, the UE provides transmission service for either an ACK or an NACK message to be transmitted to node B by radio interface layer 1 processing operations. The UE sends one of these messages on the dedicated control channel.

### PROBLEMS THAT THE INVENTION IS TO SOLVE

However, when the UE fails to detect the control information intended for that UE, no ACK or NACK message is generated. This results in the UE sending nothing, or more precisely sending a discontinuous transmission (DTX) on the allocated dedicated control channel. According to existing telecommunications standards, node B is required to interpret the DTX as a NACK message. Similarly, when the UE detects the control information intended for that UE, but the error checking process is failed, the UE is unable to decode the received data packet. Once again, this results in a DTX being sent on the allocated dedicated control channel, and in node B being required to interpret the DTX as an NACK message.

It has been found that a number of issues may arise, particularly in a mobile environment where transmitted signals are subject to fast fading, that deteriorate the performance of an HSDPA system. Node B may interpret DTX as an ACK message, rather than an NACK message, due to the presence of channel noise. Upon interpretation of DTX as an ACK message, node B will then send new packet data to the intended UE in a subsequent round of scheduling. This packet data caused the corruption of the H-ARQ buffer in the UE, resulting in performance degradation. The continuation of buffer corruption due to poor performance of node B in recognising DTX as an ACK message also caused link termination in HSDPA activities and wastes UE power consumption. The situation becomes more severe where services require data packets to be delivered to the UE in order In this case, data packets that have been received successfully after the previously corrupted data packets are also disregarded by the UE, as the data packet is out of order.

It would desirable to provide a technique for improving ARQ control in an HSDPA communications system that results in an enhanced detection of NACK messages at node B.

It would also be desirable to improve ARQ control in a HSDPA communications system in a manner that ameliorates or overcomes one or more problems associated with known HSDPA communication systems.

### DISCLOSURE OF THE INVENTION

One aspect of the invention provides a method of Automatic Repeat request (ARQ) control in a High Speed Downlink Packet Access (HSDPA) communication system, the method including:

transmitting a control information from a first station to a second station;

commencing receipt of the control information at the second station;

checking whether the control information was received with error; and if so,

generating a negative acknowledgment (NACK) message for transmission to the first station,

wherein the control information error checking and acknowledgment message generating is performed at the second station by carrying out processing operations within radio interface layer 1.

The control information error checking is preferable carried out by performing a cyclic redundancy check on the control information.

The control information error checking is preferable carried out during receipt of an associated data packet.

The method may further include:

terminating receipt of the associated data packet at the second station upon failure of the control information error checking by carrying out processing operations within radio interface layer 1.

The control information may be transmitted and received on a common control channel.

The method may further include:

transmitting the negative acknowledgment (NACK) message from the second station to the first station on the common control channel.

Another aspect of the invention provides a communication station forming part of a High Speed Downlink Packet Access (HSDPA) communication system, the communication station including:

receiving means for receiving control information transmitted from another station; and

processing means for checking whether the control information was received with error; and if so,

generating a negative acknowledgment (NACK) message for transmission to the first station,

wherein the control information error checking and acknowledgment message generating is performed at the second station by carrying out processing operations within radio interface layer 1.

### BRIEF DESCRIPTION OF THE DRAWINGS

The following description refers in more detail to the various features of the method and communication station of the present invention. To facilitate an understanding of the invention, reference is made in the description to the accompanying drawings where the invention is illustrated in a preferred embodiment. It is to be understood however, that the invention is not limited to the preferred embodiment shown in the drawings.

In the drawings:

FIG. 1 is an architectural model of a number of inter-related layers for performing functions in a communications system;

FIG. 2 is a schematic diagram of a mobile station (UE) and a base station (node B) forming part of a communications system in accordance with the present invention;

FIG. 3 is a timing diagram illustrating information flow and processing operations performed during HSDPA activity in a prior art communications system;

FIG. 4 is a timing diagram illustrating operation of a prior art communication system when a UE fails to detect control information intended for that UE;

FIG. 5 is a timing diagram illustrating the case where a UE of a prior art communication system detects control information intended for that UE but the control information fails an error checking procedure; and

FIG. 6 is a timing diagram illustrating data flow and processing operations performed by the communications system shown in FIG. 2 in accordance with the present invention.

### BEST MODE FOR CARRYING OUT THE INVENTION

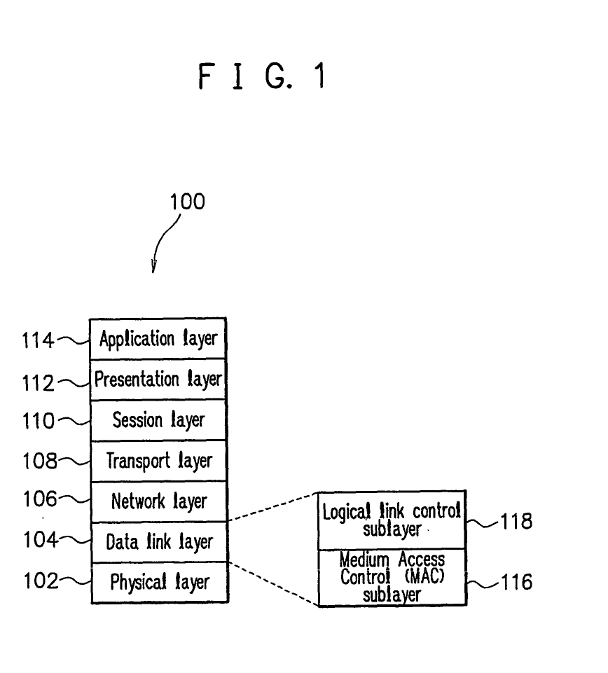

Referring now to FIG. 1, there is shown generally a seven-layer open systems interconnection model designed to support most types of communication systems. Each of the layers does not specify precise protocols or services, but rather defines a model for the functions that need to be performed. The model 100 includes a physical layer 102, data link layer 104, network layer 106, transport layer 108, session layer 110, presentation layer 112 and application layer 114.

The physical layer 102 acts to condition digital data from higher layers so that it can be transmitted over a mobile radio channel reliably. In the transmit direction, the physical layer 102 performs functions such as channel coding, interleaving, scrambling, spreading and modulation. In the received direction, these functions are reversed so that the transmitted data is recovered at the receiver.

The data link layer 104 is responsible for transforming data from a physical layer into a frame. The data link layer 104 also incorporates some form of error detection function, so that if there is an error in the received data, the data link layer is responsible for error control, informing the transmitting entity of the existence of the error. The data link layer is split into two sublayers, namely a Medium Access Control (MAC) sublayer 116 and a logical link control sublayer 118. The MAC sublayer 116 works more closely with the physical layer and contains a header, physical addresses, error detection codes and control information. The logical link control sublayer 118 on the other hand is primarily responsible for logical addressing and providing error control and flow control information.

The network layer 116 is responsible for creating, maintaining and editing network connections between network entities. The network layer also performs congestion control. The transport layer 108 performs end to end error and flow control. The session layer 110 is responsible for establishing sessions between users, for handling the service of token management and for establishing synchronisation points in the network. The presentation layer 112 performs a series of miscellaneous functions necessary for presenting a data package properly to a sender or receiver. Finally, the application layer 114 is where an application using the communications network resides.

The physical layer 102 and data link layer 104 are respectively referred to a radio interface layers 1 and 2. Radio interface layer 2 provides channel integrity, error control, flow control and link sequencing to its lower layer, namely radio interface layer 1. The most common technique for error control are based upon the functions of error detection, in which a receiver is able to detect errors in an incoming sequence, and Automatic Repeat request (ARQ), wherein an error is detected in the incoming sequence and the receiver requests to the source that additional symbols be transmitted. Mobile radio environments are characterised by non-stationery channels that are responsible for varying bit error rates. In order to reduce the damaging effect of these bit error rates in data transfer, Forward Error Correcting (FEC) coding schemes are widely used. Methods resulting in a combination of FEC coding and ARQ are called Hybrid ARQ (H-ARQ) methods. H-ARQ processing operations are carried out in the MAC sublayer of radio interface layer 2.

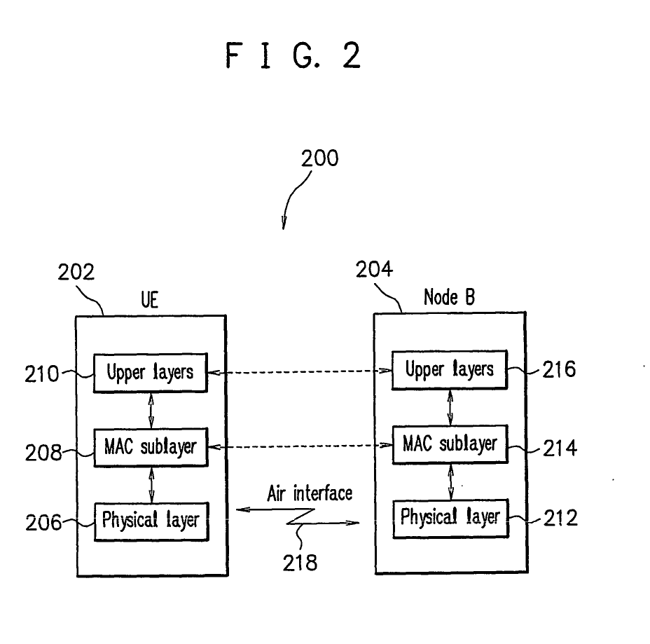

FIG. 2 illustrates an HSDPA communication system 200 including two communication stations, namely a UE 202 and a node B 204. Each of the communication stations includes processing sections for carrying out operations to be performed by each of the layers in the model shown in FIG. 1. Accordingly, FIG. 2 shows a physical layer processing block 206, a MAC sublayer processing block 208 and an upper layers processing block 210. Similarly, the node B station 204 includes a physical layer processing block 212, a MAC sublayer processing block 214 and an upper layers processing block 216. Whilst actual data is transmitted between the stations 202 and 204 via an air interface 218, each of the processing sections effectively communicates with a corresponding processing section in the other station in a peer-to-peer relationship.

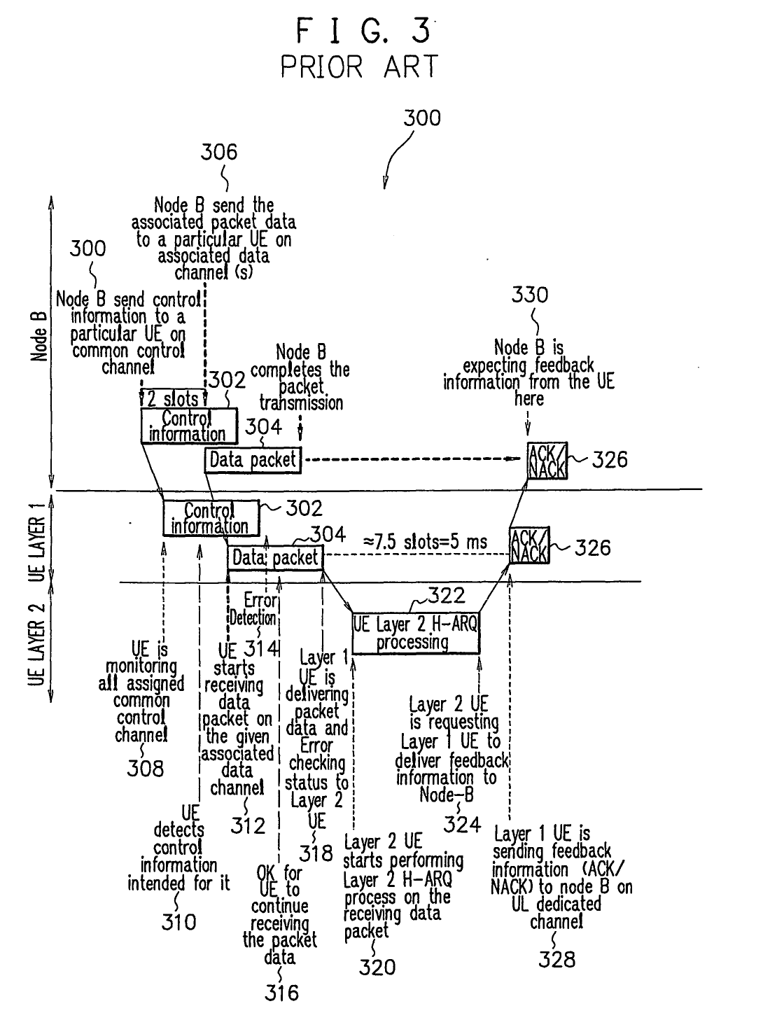

As can be seen in the timing diagram 300 shown in FIG. 3, when HSDPA activity is activated via the peer-to-peer communication of higher layers within both node B 204 and the UE 202 in known HSDPA communication systems, node B sends control information 302, at step 300, intended for the UE 202 on a common control channel. The control information enables the UE 202 to receive and decode packet data 304 on an associated data channel which is sent by node B exactly 2 slots (4/3 ms) later at step 306. The UE 202 monitors the given common control channel at step 308 to detect information intended for the UE. Once this control information is detected at step 310 by the UE, the UE starts receiving the packet data 304 on the associated data channel at step 312, by using the partially decoded control information 302. Whilst the packet data 304 is being received by the UE, the UE continues retrieving control information 302 on the detected control channel and, at step 314, performs error detection to determine whether the control information has been received with error. This error detection is carried out by performing a cyclic redundancy check on the control information 302. If no error is detected, at step 316, the UE will continue receiving and decoding the packet 304.

Each of the functions performed at steps 308 to 316 are carried out by the UE 202 by performing operations within the radio interface layer 1 processing section 206. Upon completion of receiving and decoding the packet data 304, the packet data is sent, at step 318, to the MAC sublayer processing section 208 to perform further processing operations within radio interface layer 2. Notably, at step 320, the radio interface layer 2 processing sections perform layer 2 H-ARQ processing operations 322. At the conclusion of the layer 2 H-ARQ processing operation, the MAC sublayer processing section 208 will request, at step 324, the physical layer processing section 206 within radio interface layer 1 to provide transmission service for the positive (ACK) or negative (NACK) acknowledgement messages to indicate to node B 204 whether data transmitted was with or without error. The generation of the ACK message or NACK message occurs about 7.5 slots (5 ms) after the end of the data packet reception by the UE 202.

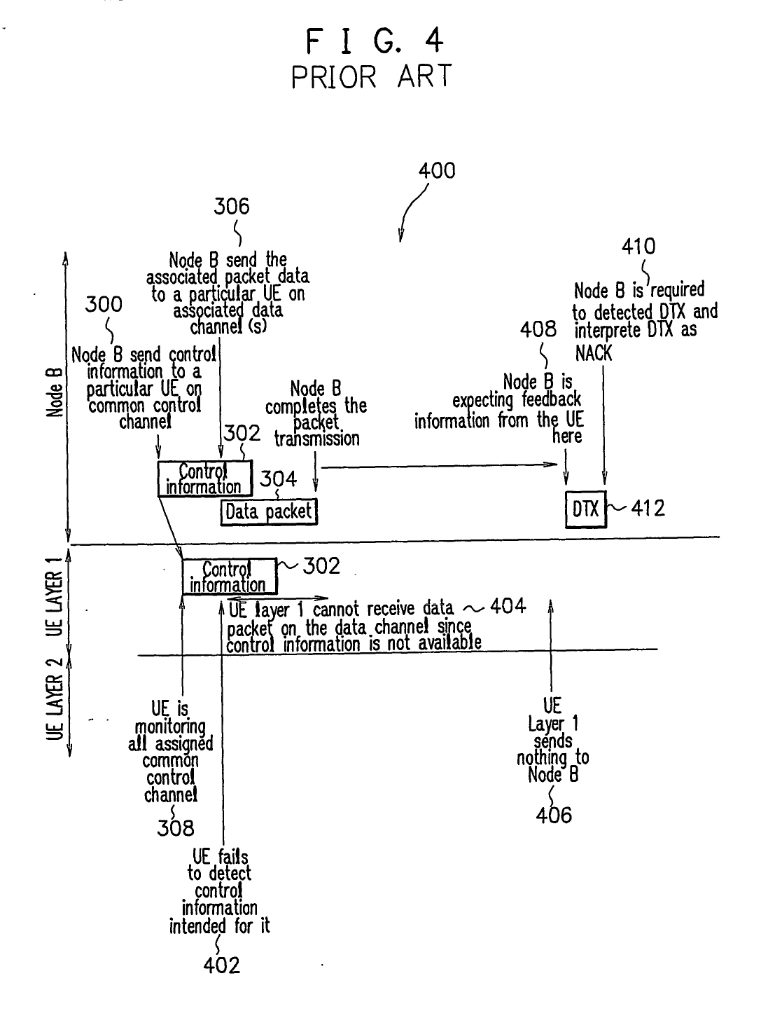

As can be seen in the timing diagram 400 shown in FIG. 4, if the UE 202 instead fails to detect control information 302 intended for the UE at step 402, the UE will be unable to receive the packet data 304, at step 404. This will result in no request being made from the MAC sublayer processing section 208 to the physical layer processing section 206 to provide transmission service for feedback information at step 406. A Discontinuous Transmission (DTX) will be detected by node B 204 at step 408. The detected DTX is then interpreted at step 410 as a NACK message in accordance with existing telecommunications standards.

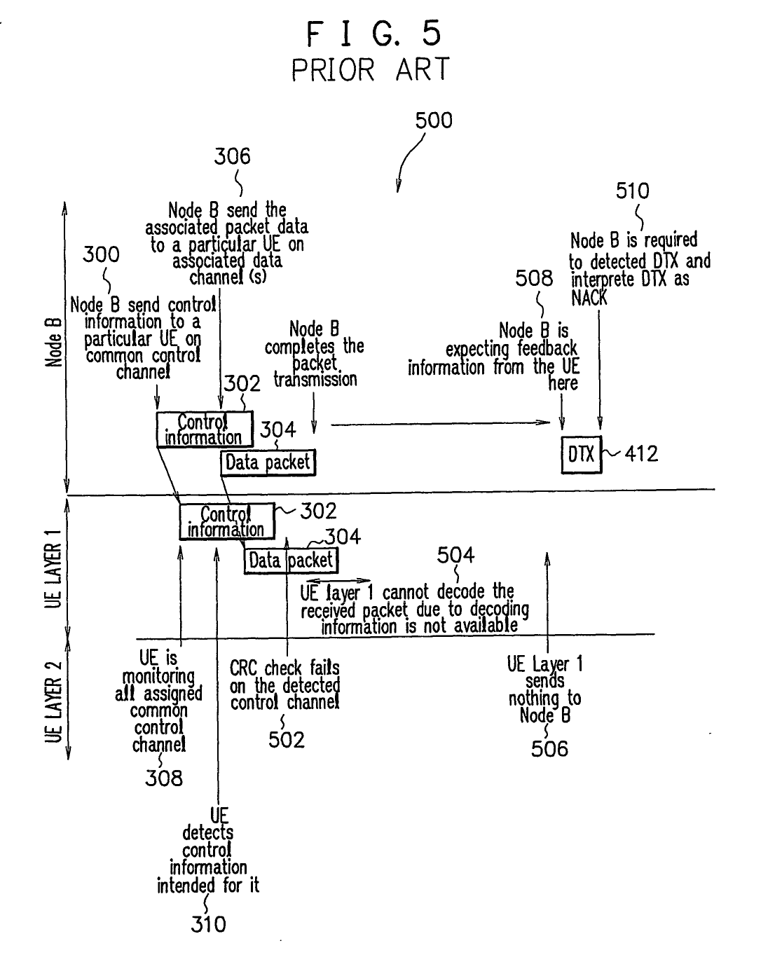

The timing diagram 500 in FIG. 5 illustrates a similar case where the UE 202 successfully detects the control information 302 intended for the UE in the radio interface layer 1, but a cyclic redundancy check performed on the control information 302 fails at step 502. This results in the UE layer 1 processing section being unable to decode the received data packet 304, at step 504, and results in a Discontinuous Transmission (DTX), at step 506, on the allocated dedicated control channel. The DTX 412 is detected by the node B 204, at step 508 (which was expecting to receive either an ACK message or an NACK message at this location), and interpreted by the node B 204 as an NACK message at step 510.

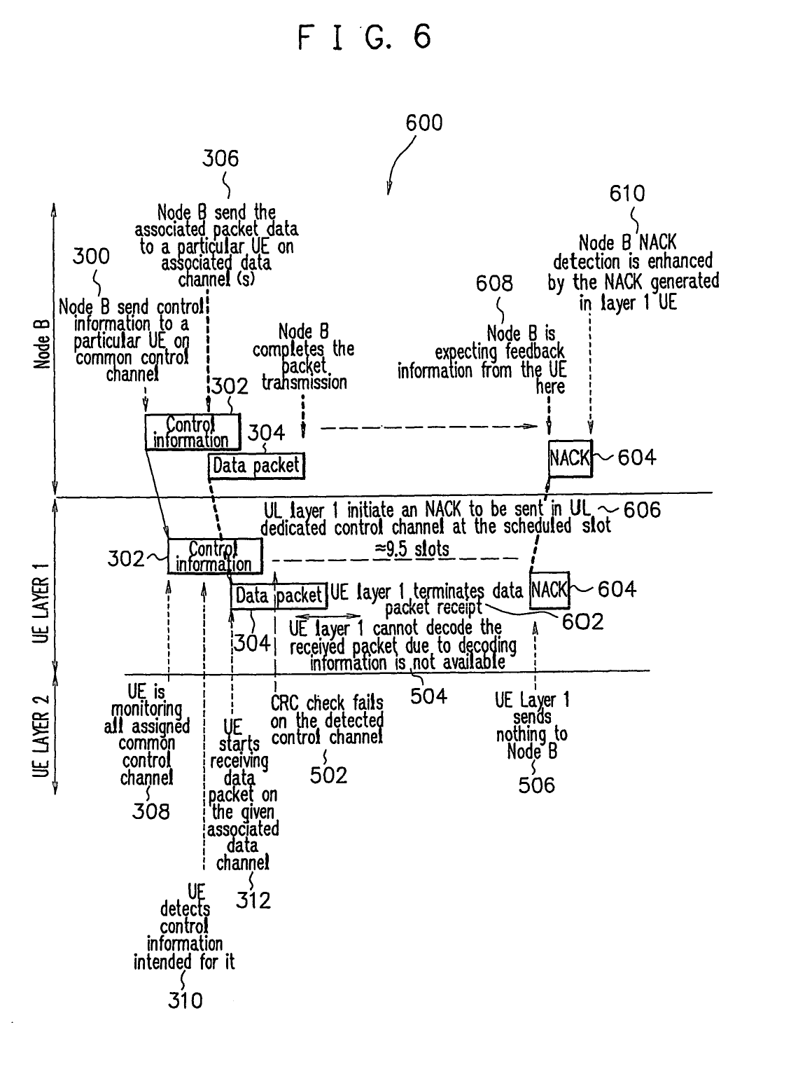

In order to avoid node B 204 inadvertently interpreting DTX 412 as an ACK message instead of an NACK message, the UE 202 acts to generate an NACK message within radio interface layer 1, and to send that NACK message on a dedicated slot on the dedicated control channel when an error is detected on the down link control information on the detected control channel. The timing diagram 600 shown in FIG. 6 illustrates the operation of the UE 202 in accordance with the present invention.

When the UE 202 is enabled for HSDPA operation, the UE 202 commences monitoring the given set of common control channels, at step 308. Upon successful detection of control information 302 intended for that UE on one of the control channels at step 310, the UE 202 starts receiving data on the associated data channel at step 312. The UE 202 continues to receive and decode the detected control information 302 received on the relevant control channel. If the cyclic redundancy check of the control information 302 fails at any time, at step 502, the UE radio interface layer 1 processing section is unable to decode the received data packet at step 504.

In this case, the UE 202 terminates reception of the data packet 304 on the associated data channel by performing radio interface layer 1 processing operations at step 602. The radio interface layer 1 processing section then initiates an NACK message 604 at step 606 to be sent on the associated control channel allocated for transmission of either an ACK message or NACK message at a later time. Currently, the period of time defined for the transmission of this feedback information message is approximately 9.5 slots from the end of the control information message 302. However, in other embodiments of the invention, the scheduled time for transmission of this feedback information message may be varied or allowed to be configurable to enhance system flexibility in scheduling.

This enhancement enables a reallocation of the MAC sublayer ACK message/NACK message generation function to radio interface layer 1 processing operations. This has the effect of speeding up processing and reducing unnecessary traffic between radio interface layers 1 and 2 in the case of errors on HSDPA packet data. It will be appreciated that the present invention is implementation dependent and will cause no impact on compliance with existing telecommunication standards.

The present invention effectively over-lays existing radio interface layer 2 ACK message/NACK message generation functionality but, in the case where radio interface layer 2 generates nothing for radio interface layer 1 to send to node B 204, at step 506, and where a cyclic redundancy check fails on control information on the detected control channel, then the radio interface layer 1 causes a NACK message 604 to be generated for transmission to the node B 204. The node B 204 monitors feedback information received from the UE 202 at step 608, and at step 610 determines that the NACK message 605 has been detected.

Finally, it is to be understood that various modifications and/or additions may be made to the above described HSDPA feedback scheme for ACK/NACK messages without departing from the spirit or ambit of the invention.

1. A method of Automatic Repeat reQuest (ARQ) control in a High Speed Downlink Packet Access (HSDPA) communication system, the method including:
transmitting control information from a first station to a second station;
commencing receipt of the control information at the second station;
checking whether the control information was received with error; and if so,
generating a negative acknowledgment (NACK) message for transmission to the first station,
wherein the control information error checking and acknowledgment message generating is performed at the second station by carrying out processing operations within radio interface layer 1.

2. A method according to claim 1, wherein the control information error checking is carried out by performing a cyclic redundancy check on the control information.

3. A method according to claim 1, wherein the control information error checking is carried out during receipt of an associated data packet.

4. A method according to claim 1, and further including:
terminating receipt of the associated data packet at the second station upon failure of the control information error checking by carrying out processing operations within radio interface layer 1.

5. A method according to claim 4, wherein the control information is transmitted and received on a common control channel.

6. A method according to claim 1, and further including:
transmitting the negative acknowledgment (NACK) message from the second station to the first station on the common control channel.

7. A communication station forming part of a High Speed Downlink Packet Access (HSDPA) communication system, the communication station including:
receiving means for receiving control information transmitted from another station; and
processing means for checking whether the control information was received with error; and if so,
generating a negative acknowledgment (NACK) message for transmission to the first station,
wherein the control information error checking and acknowledgment message generating is performed at the second station by carrying out processing operations within radio interface layer 1.

8. A communication station according to claim 7, wherein the processing means acts to carry out the control information error checking by performing a cyclic redundancy check on the control information.

9. A communication station according to claim 7, wherein processing means acts to carry out the control information error checking during receipt of an associated data packet.

10. A communication station according to claim 7, wherein the processing means acts to terminate receipt of the associated data packet at the second station upon failure of the control information error checking by carrying out processing operations within radio interface layer 1.

11. A communication station according to claim 10, wherein the processing means acts to transmit and receive control information on a common control channel.

12. A communication station according to claim 7, wherein the processing means acts to transmit the negative acknowledgment (NACK) message from the second station to the first station on the common control channel.

13. A method according to claim 2, wherein the control information error checking is carried out during receipt of an associated data packet.

14. A communication station according to claim 8, wherein processing means acts to carry out the control information error checking during receipt of an associated data packet.
